(19) United States
(12) Patent Application Publication
(10) Pub. No.: US 2025/0149837 A1
(43) Pub. Date: May 8, 2025

(54) FUSED CURRENT TAP AND A CORD CONNECTOR FOR HIGH VOLTAGE DIRECT INSERT LIGHT STRING

(71) Applicant: DONGGUAN YONGFENG LIGHT CO., LTD, Dongguan (CN)

(72) Inventor: ZHUMEI DENG, Dongguan (CN)

(21) Appl. No.: 18/538,421

(22) Filed: Dec. 13, 2023

Related U.S. Application Data
(63) Continuation-in-part of application No. 18/505,591, filed on Nov. 9, 2023.

(30) Foreign Application Priority Data
Nov. 6, 2023 (CN) 202311461940.6
Dec. 8, 2023 (CN) 202311675960.3

(51) Int. Cl. H01R 13/68; F21S 4/10; F21V 23/06; H01R 13/502; H01R 13/66

(52) U.S. Cl. CPC H01R 13/68; F21V 23/06; H01R 13/502; H01R 13/6675; F21S 4/10

(57) ABSTRACT

A fused current tap is disclosed. The fused current tap includes an inner box having a plurality of metal blades protruding from a first end and slots at a second end opposite to the first end for receiving a plurality of wires; a printed circuit board (PCB) comprising a contact connectable to the plurality of wires; an upper cover covering at least a part of a top side of the inner box; a push cover on top of the upper cover, partially covering the upper cover; and a shell configured to house the inner box, the upper cover, and the push cover.

### CROSS-REFERENCE

This application is a continuation-in-part application of and claims the benefit of priority to U.S. patent application Ser. No. 18/505,591, filed on Nov. 9, 2023, which claims the priority of Chinese patent application no. 202311461940.6, filed on Nov. 6, 2023. This application further claims the benefit of priority to Chinese patent application no. 202311675960.3, filed on Dec. 8, 2023. The content of each of the above-referenced patent applications is incorporated by reference herein in its entirety for all purposes.

### FIELD

This disclosure generally relates to a fused current tap and a cord connector, and more particularly, to a fused current tap and a cord connector for high voltage direct insert string lights.

### BACKGROUND

A novel fused current tap and cord connector are needed for a new design of high-voltage direct insert light string.

### SUMMARY

According to embodiments of the disclosure, flat cable string lights can be mass produced and customized by soldering light emitting diode (“LED”) chips to some of the wires in a flat cable string, cutting off part of these wires to form a series connection of sets of LED lights, and adjusting the voltage of these lights through a combination of resistors and/or capacitors to allow the light string to be directly plugged into, for example, a 100V-230V power supply. The string lights can be made using flat cables with different numbers of wires (e.g., 4-wire or 5-wire flat cables) and LED chips of various sizes. Various types of function controllers can be incorporated into the string lights to produce different lighting schemes.

In one aspect, this disclosure is directed to a fused current tap and a cord connector for a high voltage direct insert light string.

### BRIEF DESCRIPTION OF THE DRAWINGS

FIG. 1 illustrates an example of a 5-wire flat cable and an example of a 4-wire flat cable, either of which can be used to make a string light, according to embodiments of the disclosure.

FIG. 2 illustrates two alternative variations of the flat cables that can be used for making string lights, according to embodiments of the disclosure.

FIGS. 3-6 illustrate LED chips being soldered to the wires of various types of flat cables, according to embodiments of the disclosure.

FIG. 7 illustrates exemplary LED chips and waterproofed versions of these LED chips that can be used in the embodiments of the disclosure.

FIGS. 8a and 8b illustrate the structures of two different LED chips.

FIG. 9 illustrates an exemplary circuit diagram illustrating the parallel connection of multiple LEDs and a multifunctional control unit that form a string light, according to an embodiment of the disclosure.

FIG. 10a illustrates an open circuit formed on a flat cable by cutting some of the wires at certain locations, according to an embodiment of the disclosure.

FIG. 10b illustrates an exemplary tube light, according to an embodiment of the disclosure.

FIG. 11 illustrates an exemplary string light manufactured according to an embodiment of the disclosure.

FIGS. 12a-12p are circuit diagrams illustrating the exemplary circuits of various light strings, according to embodiments of the disclosure.

FIG. 13 illustrates an exemplary string light with light heads/light shades being combined with the LEDs, according to an embodiment of the disclosure.

FIG. 14a is a schematic diagram of an exemplary assembly of the LED light strip with light heads and outfits, according to an embodiment of the disclosure.

FIG. 14b illustrates an exemplary LED light 1404′ of FIG. 14a, according to an embodiment of the disclosure.

FIG. 15 illustrates different views of two light heads that can be combined with the LEDs of a strong light, according to an embodiment of the disclosure.

FIG. 16 is a schematic diagram of another assembly of the light strip with light heads and outfits.

FIGS. 17a-17c illustrate exemplary application of the LED string lights disclosed herein.

FIG. 18a is a circuit diagram illustrating groups of LEDs on a single light string forming a number of connected light sources, according to an embodiment of the disclosure.

FIGS. 18b and 18c illustrate different grouping of LEDs on light strings, according to an embodiment of the disclosure.

FIG. 19a illustrates special fasteners used for clamping and support wires to form a light string, according to embodiments of the disclosure.

FIG. 19b illustrates a net lights, according to an embodiment of the disclosure.

FIG. 20 is a flow chart illustrating the exemplary steps in a method of making a string light, according to an embodiment of the disclosure.

FIG. 21A is a schematic diagram of string light made from a 5-wire flat cable, according to an embodiment of the disclosure.

FIG. 21B is a schematic diagram of string light made from a 4-wire flat cable, according to an embodiment of the disclosure.

FIG. 22A is an exploded diagram of an assembly of a fused current tap, according to an embodiment of the disclosure.

FIG. 22B-22D are diagrams illustrating the various stages of assembling the fused current tap of FIG. 22A.

FIG. 23A is an exploded diagram of an assembly of a cord connector, according to an embodiment of the disclosure.

FIGS. 23B and 23C are diagrams illustrating the various stages of assembling the cord connector of FIG. 23A, according to an embodiment of the disclosure.

FIGS. 24A and 24B illustrate the stages of connecting the fused current tap of FIG. 22A and the cord connector of FIG. 23A, according to an embodiment of the disclosure.

FIG. 25 is a circuit diagram of an exemplary string light without any rectifier circuit, according to an embodiment of the disclosure.

FIG. 26 is a circuit diagram of an exemplary string light with a rectifier circuit, according to an embodiment of the disclosure.

FIG. 27 is a circuit diagram of an exemplary string light with a rectifier circuit, according to another embodiment of the disclosure.

### DETAILED DESCRIPTION

Embodiments of the present disclosure will be described below in conjunction with the accompanying drawings, but it should be appreciated by those skilled in the art that the embodiments described below are exemplary, rather than exhaustive. They are only used to illustrate the present disclosure and should not be regarded as limiting the scope of the present disclosure. All other embodiments obtained by those of ordinary skill in the art without creative efforts based on the embodiments disclosed herein shall fall within the scope of the present disclosure.

In one aspect of the disclosure, a method of making a light string (or “string light”) with LED chips is disclosed.

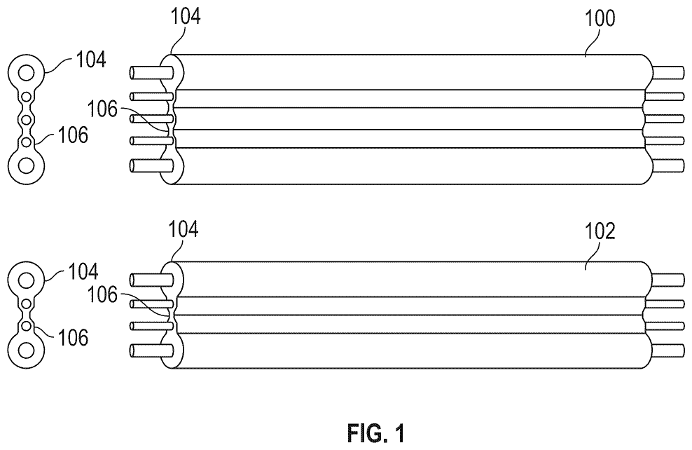

First, a flat cable with multiple wires can be provided. FIG. 1 illustrates an example of a 5-wire flat cable 100 and an example of a 4-wire flat cable 102, either of which can be used to make a string light, according to the embodiments. The flat cables 100, 102 can include copper wires of different sizes based on the requirements of the string light. The copper wires can be wrapped with polyvinyl chloride (“PVC”) and isolated from each other. In both examples shown in FIG. 1, the diameter of the outer wires 104 can be between 1.5-3.0 mm. Each outer wire 104 can include 16 or 17 0.16 mm copper wires. The diameter of the inner wires 106 can be between 0.5-3.0 mm. Each inner wire 106 can include 7 0.12-0.15 mm copper wires. It should be understood that different sized copper wires and different number of wires can be used in various embodiments.

As illustrated in FIG. 1, the inner three wires 106 in the 5-wire flat cable 100 are relatively thin compared to the outer two wires 104. Similarly, the middle two wires 106 in the 4-wire flat cable 102 are relatively thin compared to the outer two wires 104. These wires 104, 106 can be used for parallel connection of LED chips or as signal wires. In both embodiments of FIG. 1, the outer diameter size and inner copper wire specifications can be adjusted according to the requirements of the string lights made from these flat cables.

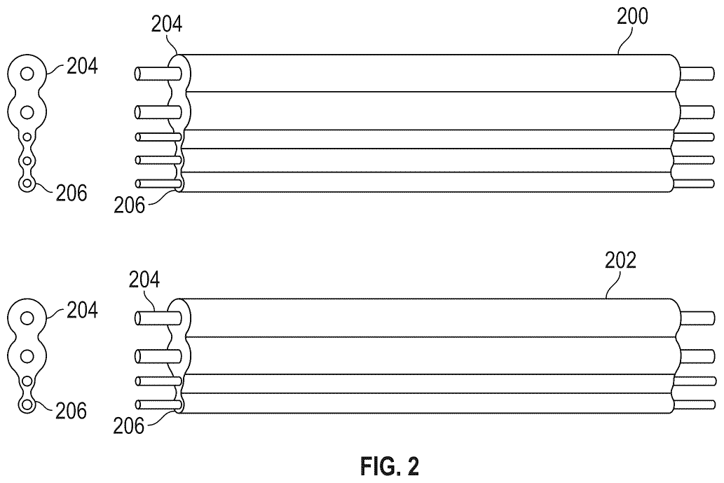

FIG. 2 illustrates two alternative variations of the flat cables that can be used for making string lights, according to embodiments of the disclosure. As shown in FIG. 2, the two wires 204 on one side of the 5-wire flat cable 200 are relatively thick compared to the three wires 206 on the other side. The size of the wires can be adjusted according to needs. In one example, the outer diameter of each of the two thick wires 204 can be 1.5-3.0 mm. Each of the outer wires can include 16 or 17 0.16 mm copper wires. The three wires 206 on the other side of the 5-wire flat cable 200 are relatively thin compared to wires 204, as shown in FIG. 2. Similarly, the two wires 206 on one side of the 4-wire flat cable 202 are relatively thin compared to the two wires 204 on the other side of the 4-wire flat cable 202. The outer diameter of each of the wires 206 can range from 0.5-3.0 mm. Each of the wires 206 can include 7 0.12-0.15 mm copper wires. The wires of the flat cable 200, 202 of FIG. 2 can be used to connect LED chips or signal lines in parallel. The outer diameter of the wires and the specification of the inner copper wires can vary according to specific requirements.

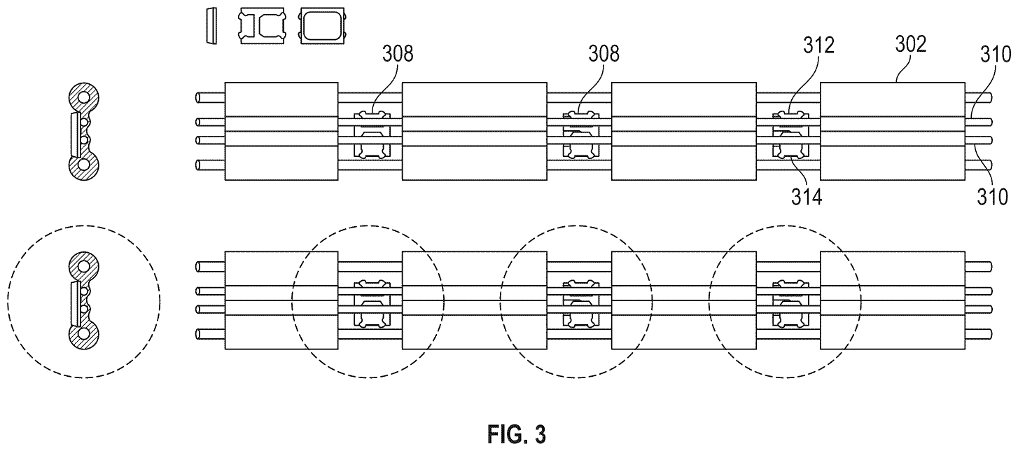

The next step, LED chips are soldered to the flat cable. FIGS. 3-6 illustrate this step being performed on the variation of the 5-wire and 4-wire flat cables of FIGS. 1 and 2.

FIG. 3 illustrates LED chips 308 soldered to a 4-wired flat cable 302. In this embodiment, the LED chips 308 can be SMD LED chips (e.g., 2835 SMD LED chips). The two poles 312, 314 of each of the SMD LED chips 308 is soldered to the two thin wires 310 in the middle of the 4-wire flat cable 302, respectively. Pot glue can then be used for fixing and protecting the LED chips 308. The shape of the potting can be molded.

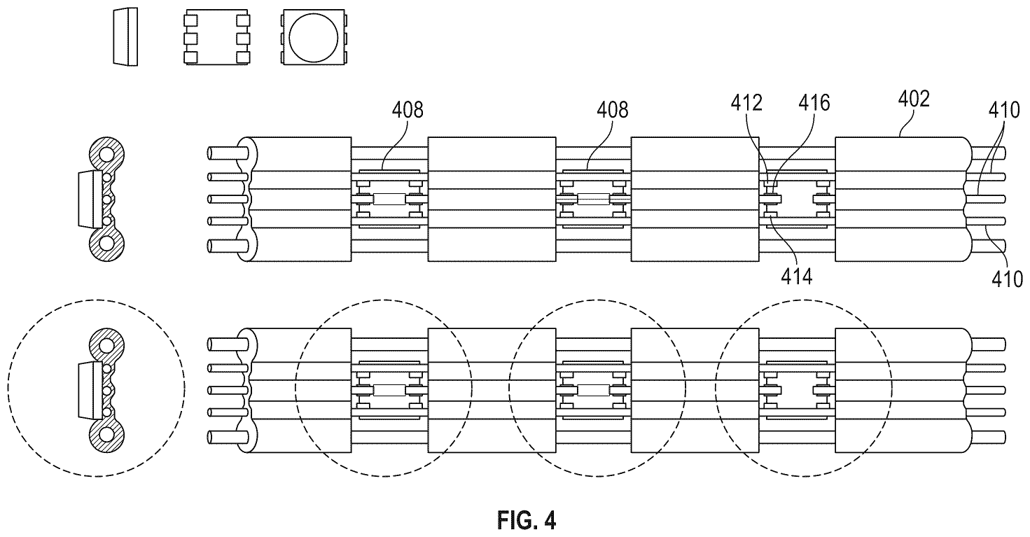

FIG. 4 illustrates the same process being performed on a 5-wired flat cable. As illustrated in FIG. 4, the poles 412, 414, 416 of the SMD LED chips 408 (e.g., 3939 SMD LED chips) are soldered to the three thin wires 410 in the middle of the 5-wire flat cable 402. Pot glue can then be used for fixing and protecting the LED chips 408. The shape of the potting can be molded.

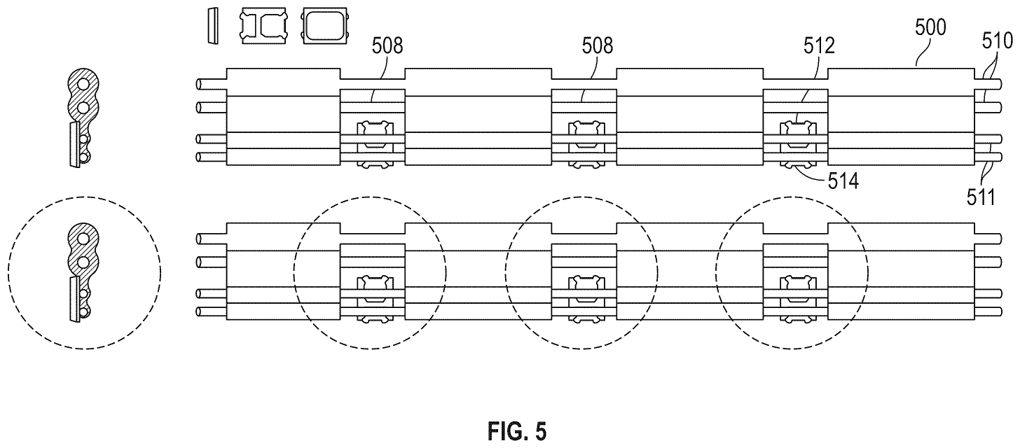

FIG. 5 illustrates the same process being performed on a 4-wired flat cable 500 with two thick wires 510 on one side and two thin wires 511 on the other side. The two poles 512, 514 of each of the SMD LED chips 508 (e.g., 2035 SMD LED chips) are soldered to two the thin wires 511 on one side of a 4-wire flat cable 500, connecting the wires 511 in parallel. Pot glue can then be used for fixing and protecting the LED chips 508. The shape of the potting can be molded.

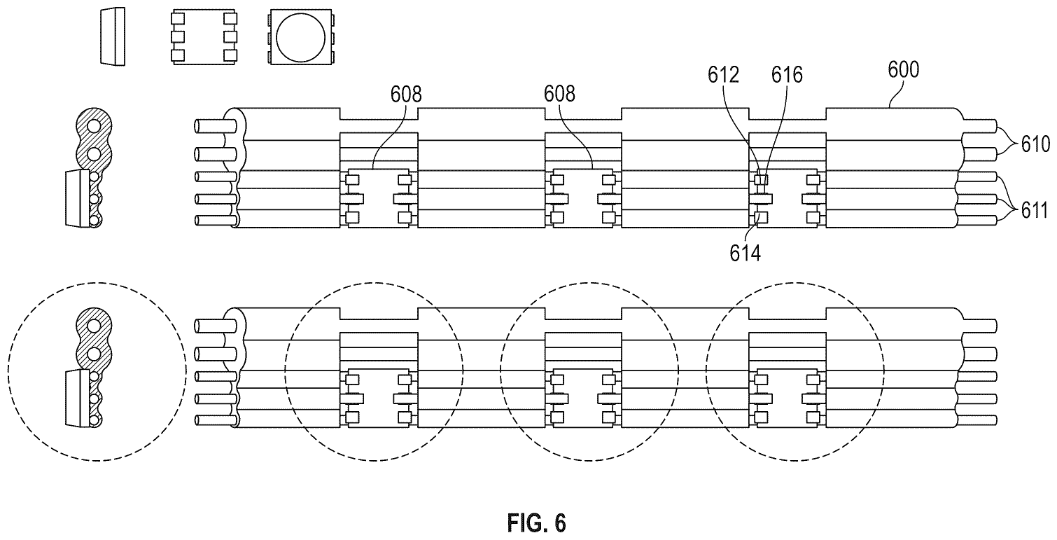

FIG. 6 illustrates the same process being performed on a 5-wired flat cable 600 with two thick wires 610 on one side and three thin wires 611 on the other side. The poles 512, 614, 616 of each SMD LED chip 608 (e.g., 3939 SMD LED chips) are soldered to the three thin wires 611 on one side of a 5-wire flat cable 600, connecting the wires 61 in parallel. Pot glue can then be used for fixing and protecting the LED chips 608. The shape of the potting can be molded.

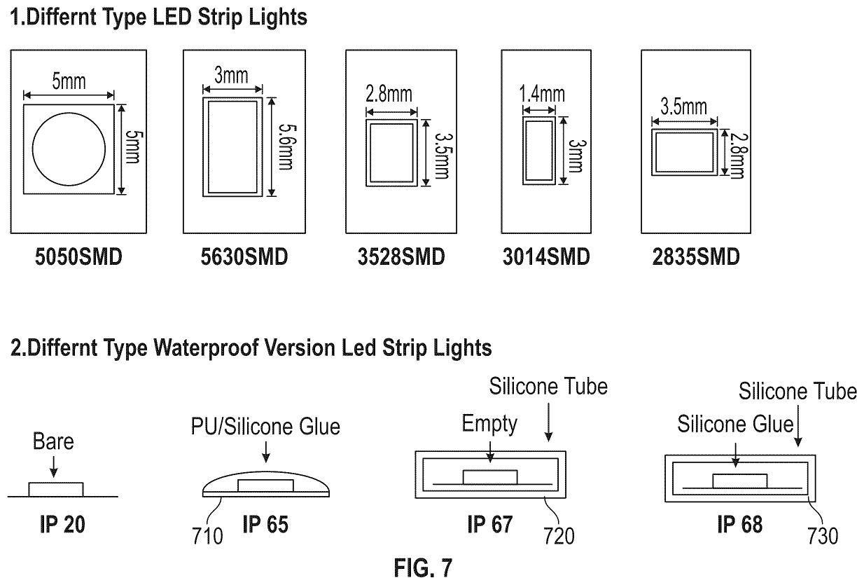

The LED chips that are connected by the flat wires in the examples shown in FIGS. 3-6 can be of various sizes, including but not limited to models: 5050SMD, 5630SMD, 3528SMD, 3014SMD, 3014SMD, 2835SMD, 2024SMD, 3939SMD, 3233SMD, some of which are shown in FIG. 7. FIG. 7 also illustrates a few different types of waterproof version of these LED chips including one encapsulated by Polyurethane/silicone glue 710, one housed in a silicone tube 720, and another covered by silicone glue and housed in a silicone tube 730.

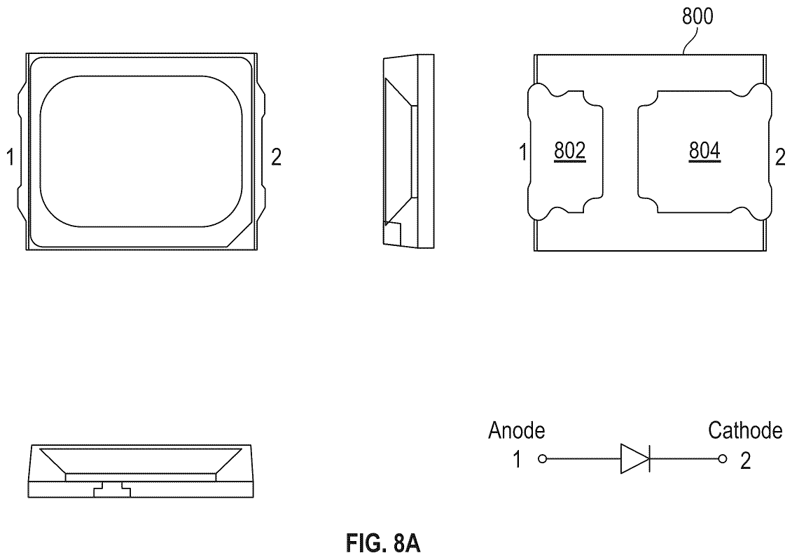

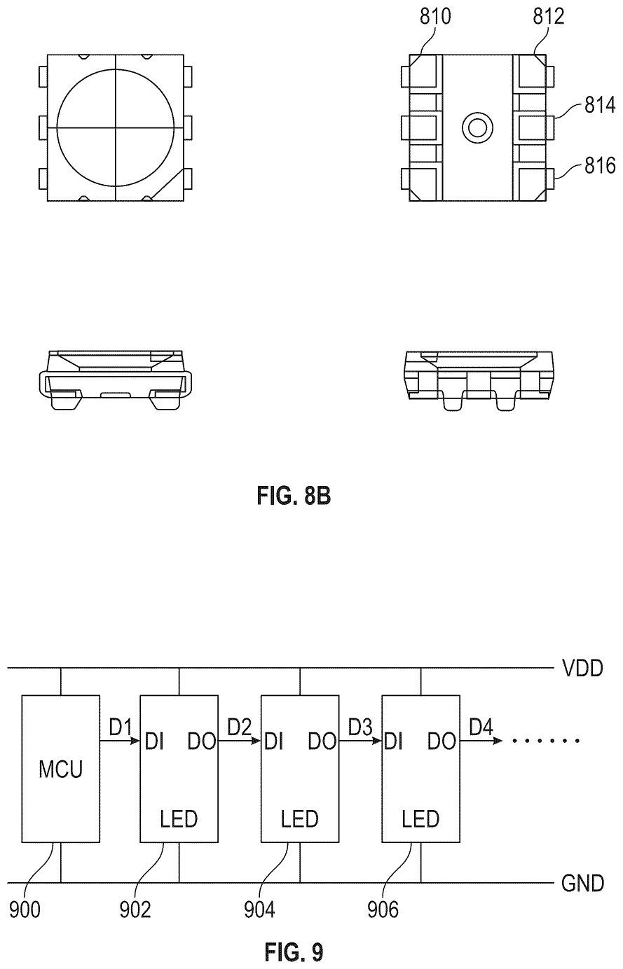

FIGS. 8a and 8b illustrate the structures of two different LED chips. FIG. 8a illustrates a 2835SMD LED chip 800 with two poles 802, 804. Specifically, the anode 802 and cathode 804 can be soldered on two of the wires in a 4-wire flat cable as shown in FIGS. 3 and 5.

FIG. 8b illustrates a 3939SMD LED chip 810 having GND (ground) 812, VDD (5 volt power) 814, and DIN (data input) 816. Each of GND 812, VDD 814, and DIN 816 can be soldered on one of the wires in a 5-wire flat cable as shown in FIGS. 4 and 6.

FIG. 9 illustrates an exemplary circuit diagram illustrating the parallel connection of the LEDs 902, 904, 906 and a multifunctional control unit 900 that form a string light. It should be understood that the mechanisms of attaching the LED chips to a flat cable according to the embodiments can work with any number of LED chips, which allows the string light to be made with any number of LEDs.

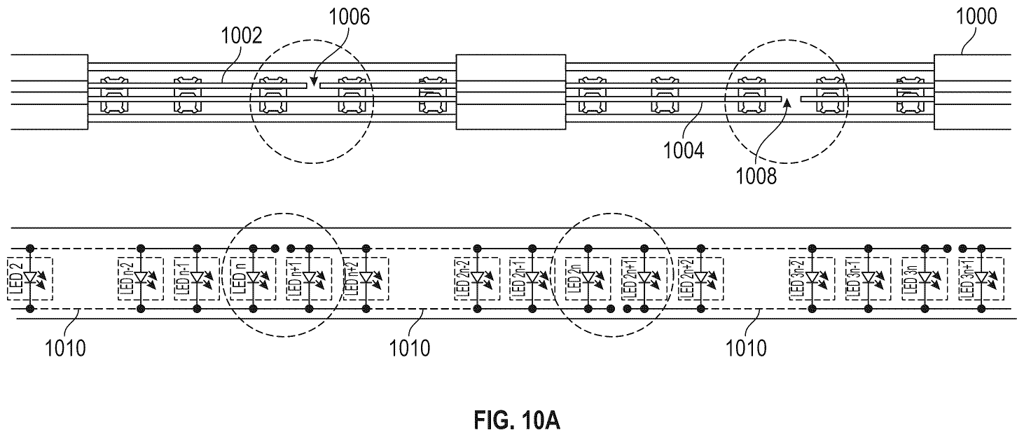

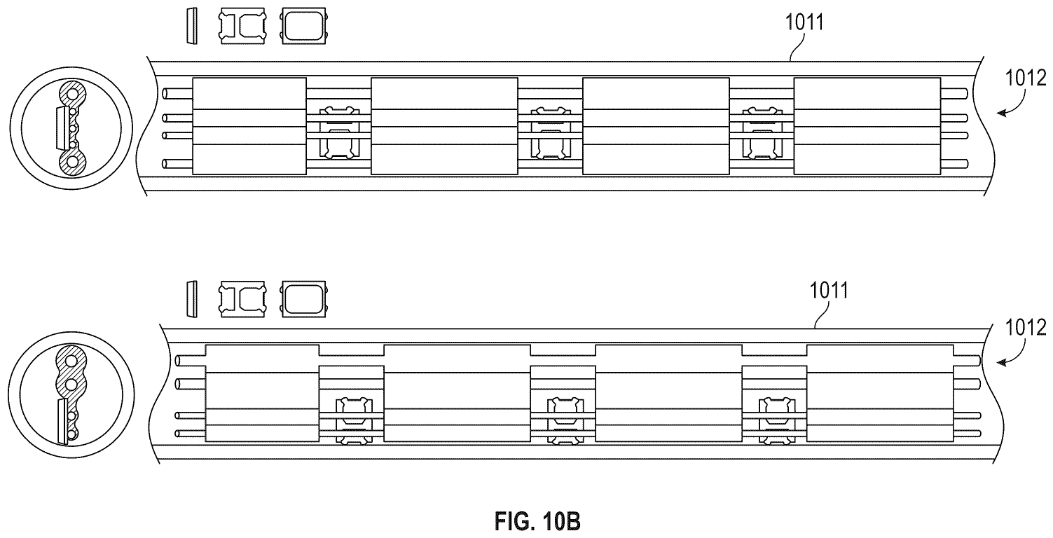

After the LED chips are soldered on the flat cable as shown in FIGS. 3-6, parts of the flat cable 1000 (e.g., some of the wires 1002, 1004) is cut at certain locations 1006, 1008 so as to form an open circuit 1010 (see FIG. 10a). The flat cable can be cut by, for example, a cutting machine, laser, heat, or other suitable processes. In one embodiment, an extruder can be used for processing an outer layer (e.g., 1011 in FIG. 10b) that can form a tube light 1012 with the light string being enclosed by the outer layer 1011.

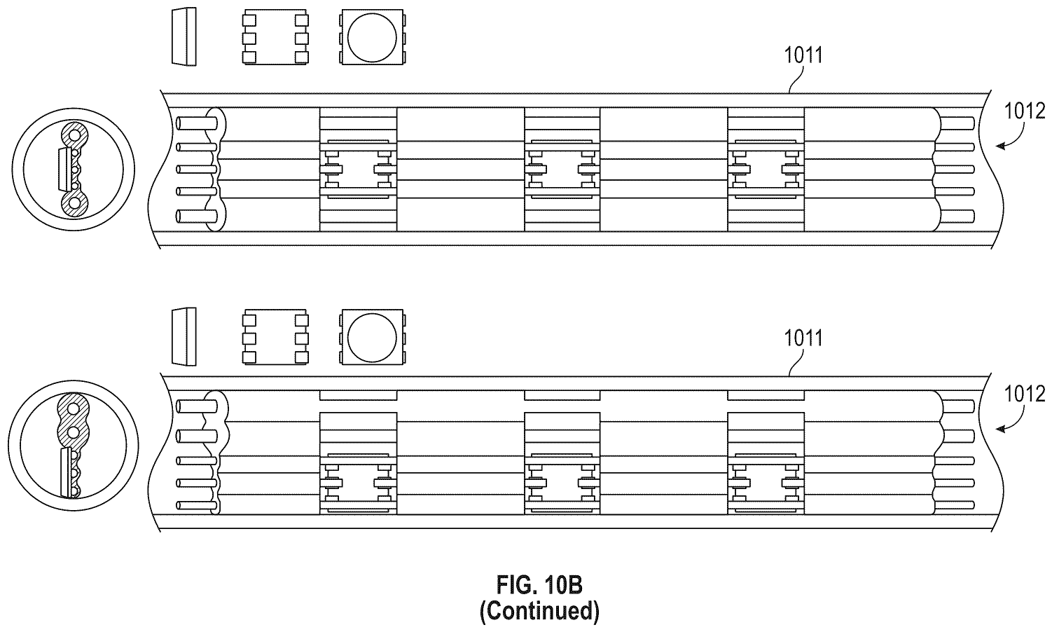

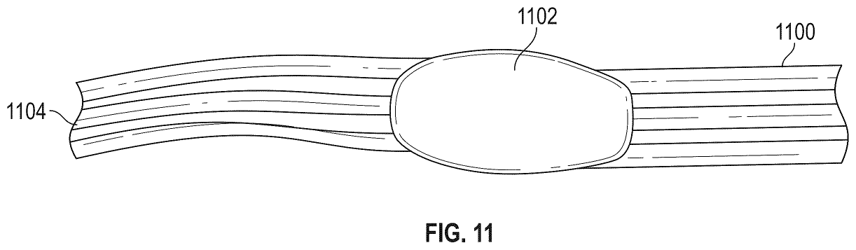

FIG. 11 illustrates an exemplary string light 1100 manufactured according to the methods disclosed herein. The string light 1100 can include one or more LED chips 1102 soldered on a flat cable 1104.

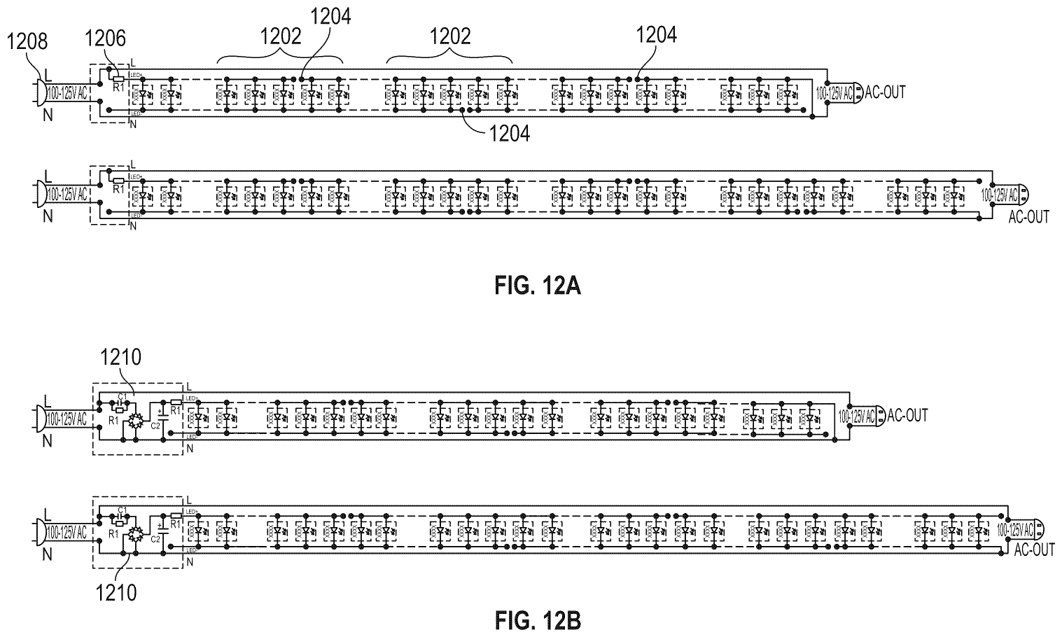

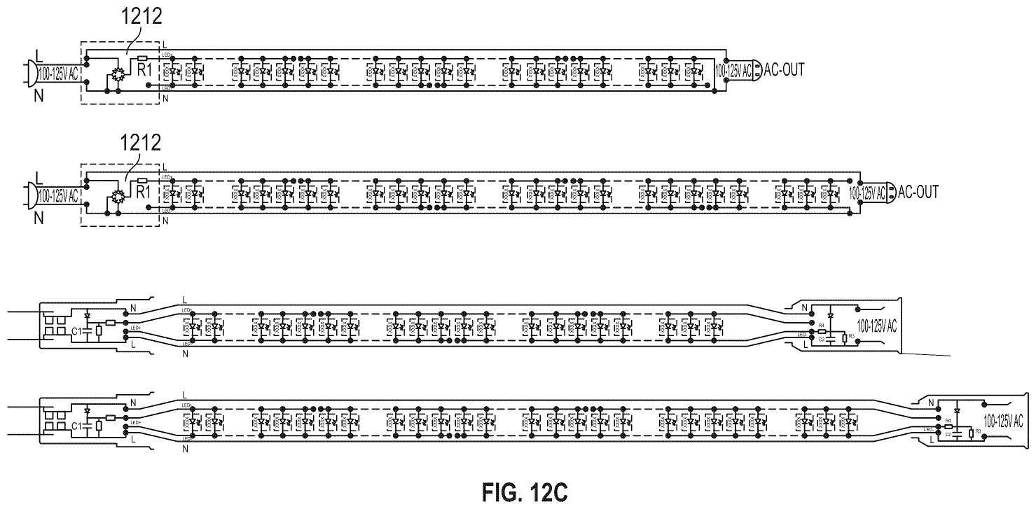

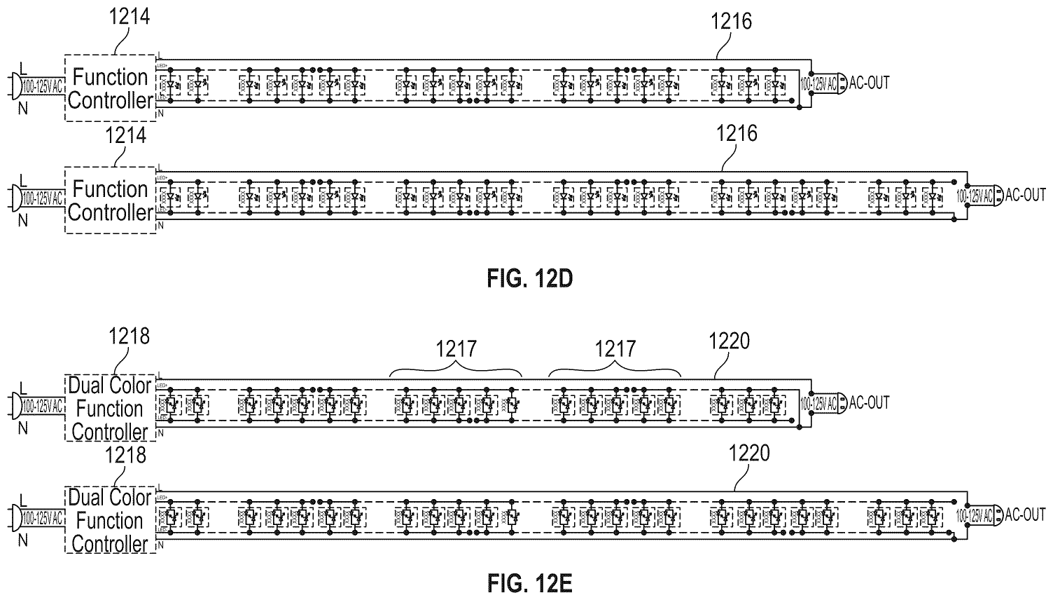

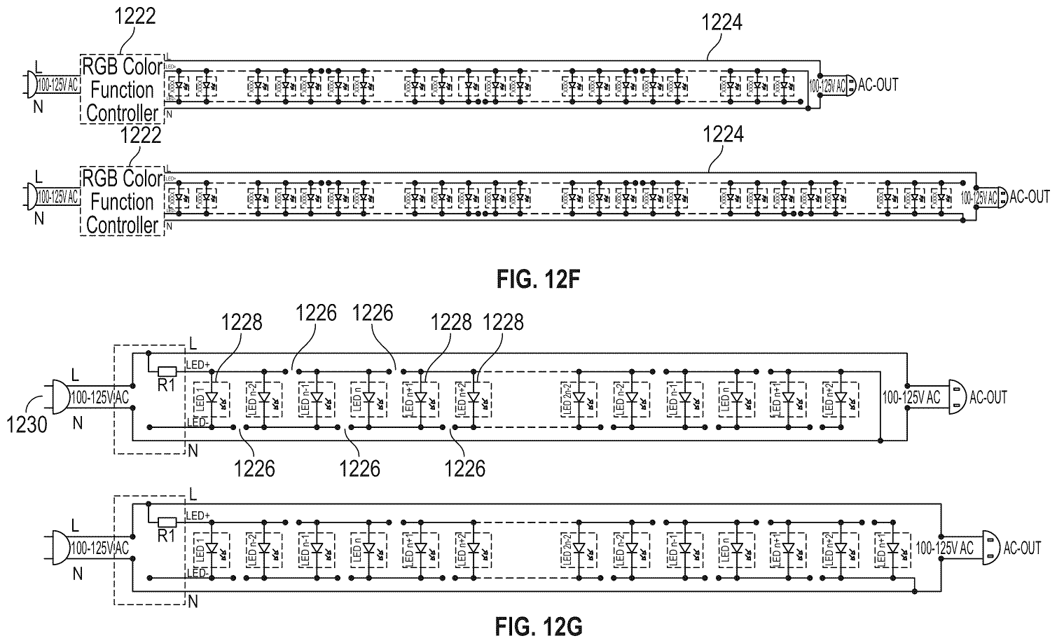

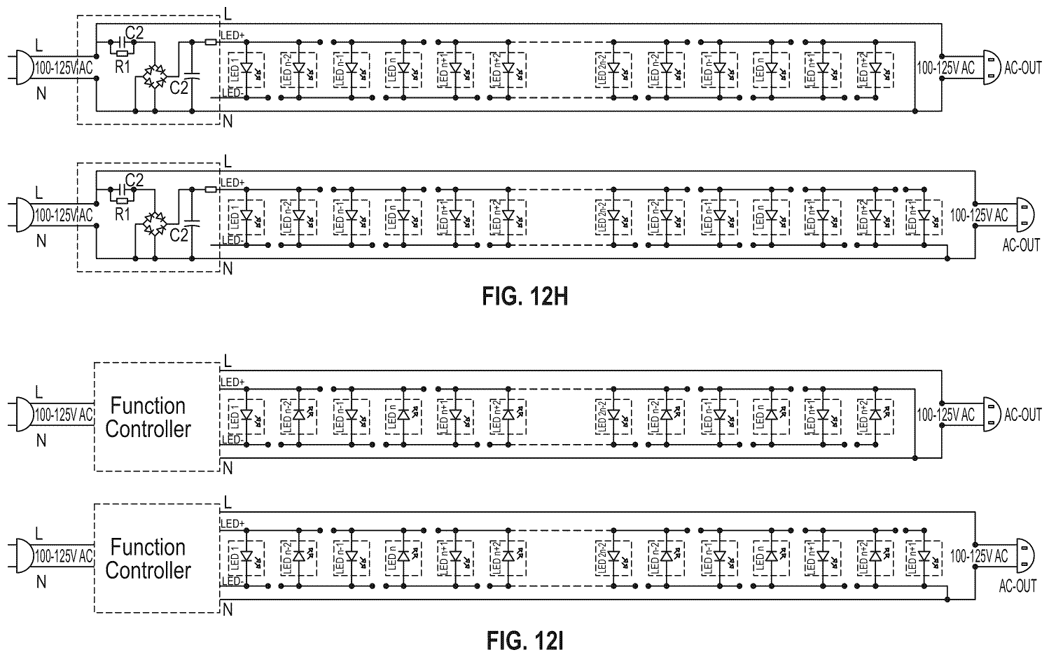

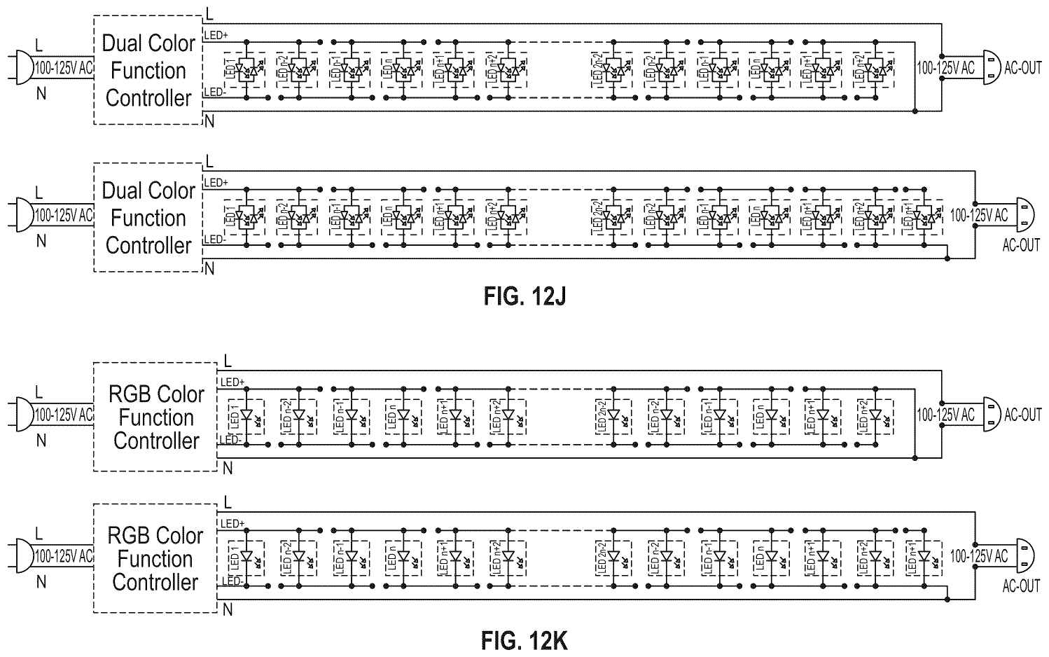

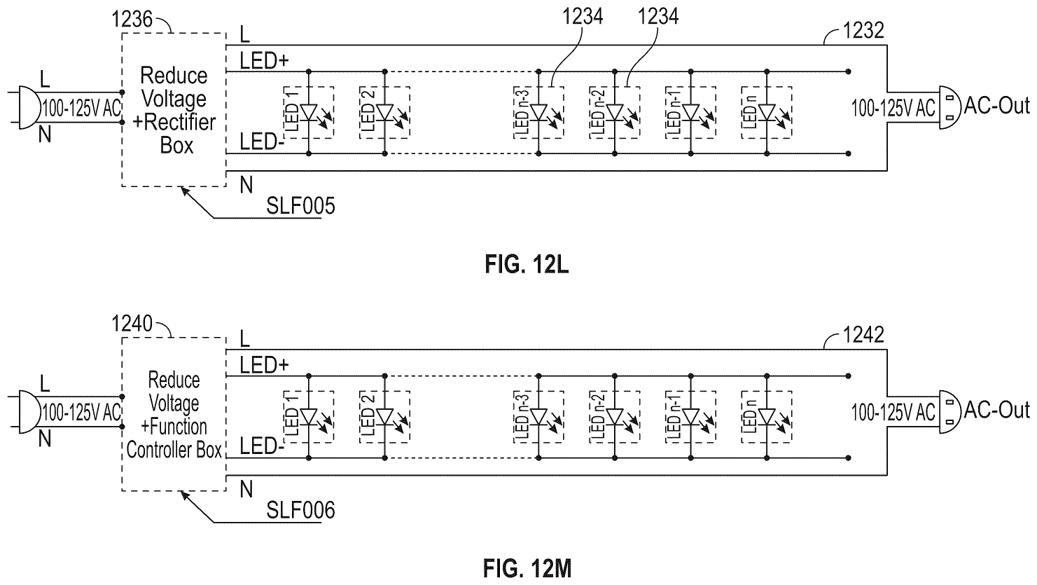

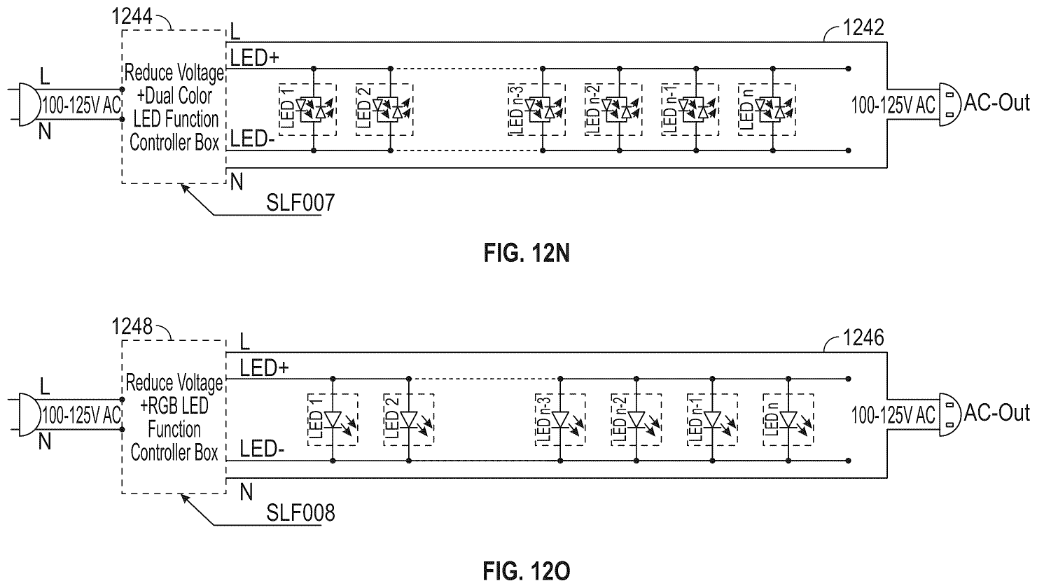

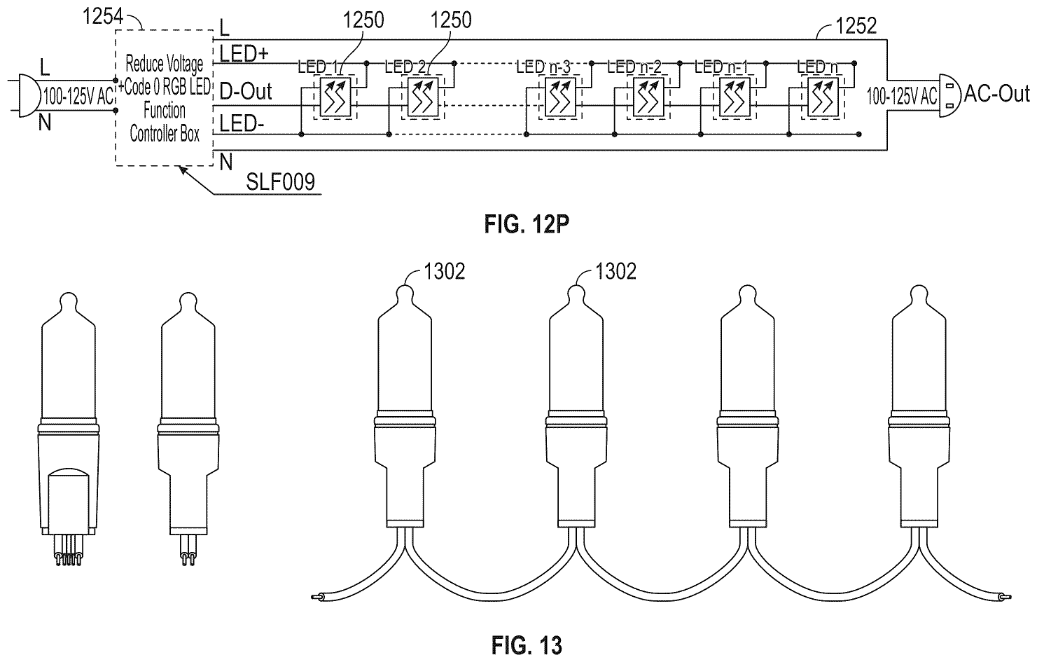

FIGS. 12a-12p illustrate circuit diagrams of various embodiments of the light strings, according to the embodiments of the disclosure.

FIG. 12a illustrates circuit diagrams of exemplary light strings produced according to an embodiment of the disclosure. The light string of FIG. 12a uses a 4-wire flat cable. Using the methods described above, n two-poled LEDs (collectively 1202) can be first connected in parallel. The wires connecting the LEDs are cut off at certain positions 1204, forming series connections of x sets of n LED lights 1202. Finally, the voltage is reduced using a resistor 1206 so the light string can be directly plugged into a 100V-230V power supply 1208 to allow the LEDs of the light string to lit up in multiple consecutive series. In one embodiment, “n” may represent any number between 1 and 100 and “x” may represent any number between 2 and 100.

FIG. 12b illustrates circuit diagrams of exemplary light strings similar to those shown in FIG. 12a but using a combination of resistors and capacitors 1210 instead of a single resistor to reduce voltage and create a different scheme of the LED light string.

FIG. 12c illustrates circuit diagrams of exemplary light strings similar to those shown in FIGS. 12a and 12b but using a different combination of resistors and capacitors 1212 to reduce voltage and create another different scheme of the LED light string. In one embodiment, the ends of the light strings 1213 can incorporate a special fused current tap and a cord connector body 1211.

FIG. 12d illustrates circuit diagrams of exemplary light strings similar to those shown in FIGS. 12a-c but each with a function controller 1214 at the plug end of circuit to reduce voltage and control the lighting scheme of the LED light string 1216.

FIG. 12e illustrates circuit diagrams of exemplary light strings 1220 similar to those shown in FIGS. 12a-d but with dual color LEDs 1217 and a dual color function controller 1218 at the plug end of circuit to reduce voltage and control the lighting scheme of the LED light string 1220. The dual color function controller 1218 can provide a two-color lighting scheme for the LED light string 1220.

FIG. 12f illustrates circuit diagrams of exemplary light strings 1224 similar to those shown in FIGS. 12a-e but each with a RGB color function controller 1222 at the plug end of circuit to reduce voltage and control the lighting scheme of the LED light string 1224. The RGB function controller 1222 can provide an RGB lighting scheme of the LED light string 1224.

The circuits illustrated in FIGS. 12g, 12h, 12i, 12j, 12k also use 4-wire flat cables with two-pole SMD LEDs soldered to two of the four wires of each flat cable. By cutting off the wires at the positions (e.g., 1226 in FIG. 12g) shown in the figures, n LEDs (e.g., 1228 in FIG. 12g) are connected in series, and then connected in parallel to the main power supply (e.g., 1230 in FIG. 12g). This enables a continuous connection of multiple LEDs on a light string for lighting.

Similar to the circuits shown in FIGS. 12a, 12b, 12d, 12e, 12f, the various light strings of FIGS. 12g, 12h, 12i, 12j, 12k incorporate resistor(s), capacitor(s), and/or other electronics to adjust voltage so they can be directly plugged into 100V-230V power supplies. In some embodiments shown in FIGS. 12i-12k, the circuits can include functional controllers for controlling the LEDs of the light strings.

FIG. 121 illustrates a circuit diagram of an exemplary light string, according to an embodiment of the disclosure. The light string uses a 4-wire flat cable 1232 with two-pole SMD LEDs 1234 soldered on the flat cable 1232. The voltage of the circuit is stepped down from 100V-230V to 3V-5V by resistors or combinations of resistors and capacitors of the “reduce voltage+rectifier box” 1236 so the light strip can be directly plugged into the power supply to be powered on. In one embodiment, between 1 and 1000 LEDs can be connected as shown in the illustrated circuit.

FIGS. 12m-12o illustrate circuits similar to the circuit shown in FIG. 121, but each with a different function controller box for controlling the circuits. For example, circuit 1238 of FIG. 12m includes a “reduce voltage+function controller box” to reduce the voltage and provide control signals to the circuit 1238. Circuit 1242 of FIG. 12n includes a “reduce voltage+dual color LED function controller box” 1244 to reduce the voltage and control dual color electrodeless LEDs for multifunctional use. Circuit 1246 of FIG. 12o includes a “reduce voltage+RGB LED function controller box 1248 to reduce the voltage and control RGB sync flash LEDs for multifunctional use.

FIG. 12p illustrates a circuit of a light string adopting a 5-wire flat cable 1252 with SMD LEDs 1250 soldered on three of the 5 wires of the flat cable 1252. All LEDs 1250 are connected in parallel to a string of lights. The voltage is stepped down from 100V-230V to 3V-5V by resistors or a combination of resistor(s) and capacitor(s) so the light strip can be directly plugged into the power supply to be powered on and connected in multiple strings to light up. The circuit can include a “reduce voltage+Code 0 RGB LED function controller box” 1254 that reduces the voltage and controls the Code 0 RGB LEDs for multifunctional use. In one embodiment, the circuit can include between 1 and 1000 LEDs.

The various embodiments of the light strings of FIGS. 12a-12p above can be combined with various light heads and/or light shades (e.g., 1302 of FIG. 13) to achieve different effects.

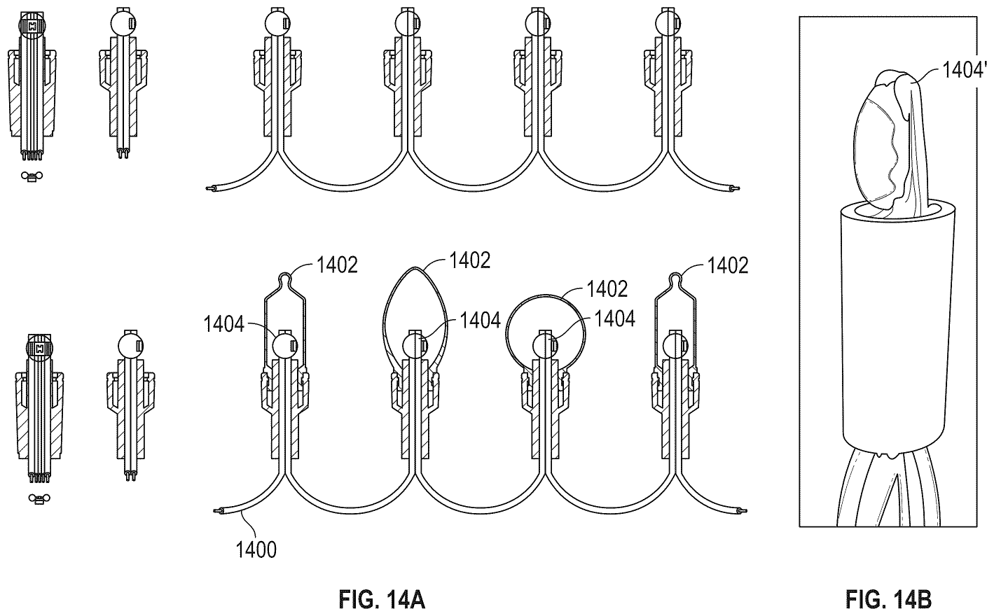

FIG. 14a is a schematic diagram of an exemplary assembly of the LED light strip 1400 with light heads and outfits 1402, according to an embodiment of the disclosure. The light various heads and outfits 1402 can encapsulate the LEDs 1404 of the light strip 1400 to achieve different lighting effects. FIG. 14b illustrates an exemplary LED light 1404′ of FIG. 14a.

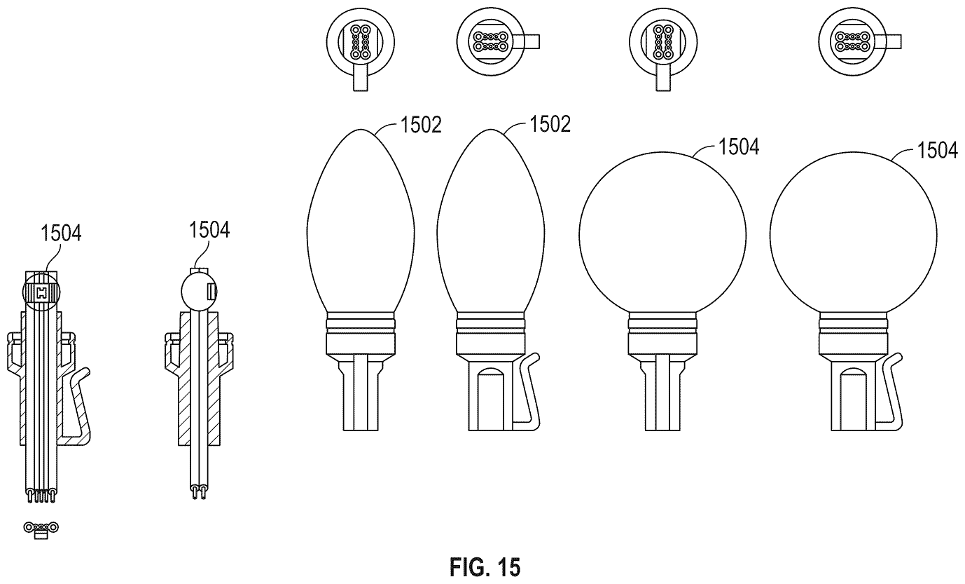

FIG. 15 illustrates different views of two light heads 1500, 1502 that can be combined with the LEDs 1504 of a strong light.

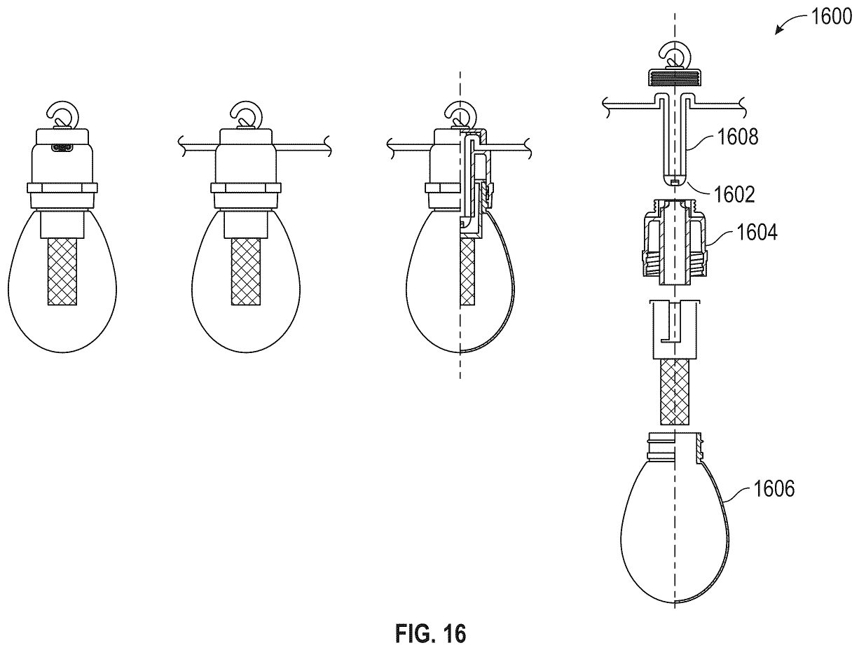

FIG. 16 is a schematic diagram of another assembly of the light strip with light heads and outfits. Because the flat cable 1608 of the light string 1600 is flexible and can be folded, an LED chip 1602 on the light string 1600 can be fitted within a base 1604 of the light assembly. A light head 1006 can be screwed on top of the base 1604 to achieve a lighting effect.

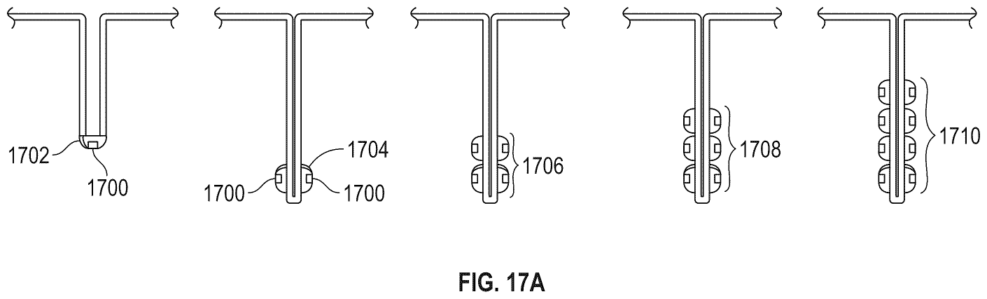

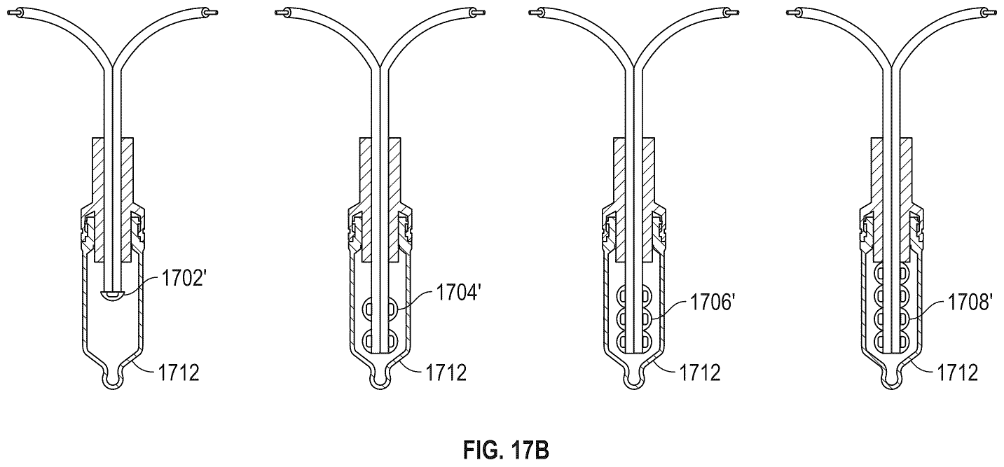

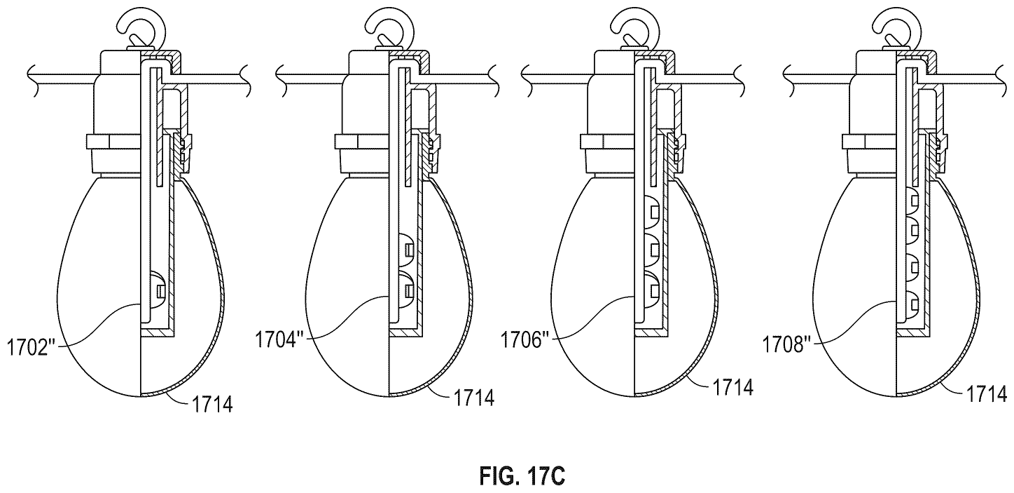

FIGS. 17a-17c illustrate exemplary application of the LED string lights disclosed herein. FIG. 17a illustrates different numbers of LED chips 1700 on a light string being grouped to form different light sources. From left to right, the light sources 1702, 1704, 1706, 1708, 1710 can be formed by 1, 2, 4, 6, and 8 LED chips, respectively. FIG. 17b illustrates the light sources 1702′, 1704′, 1706′, 1708′ being combined with light heads 1712. FIG. 17c provides a sectional view of the grouped LED chips 1702″, 1704″, 1706″, 1708″ being housed in their respective light heads (collectively 1714).

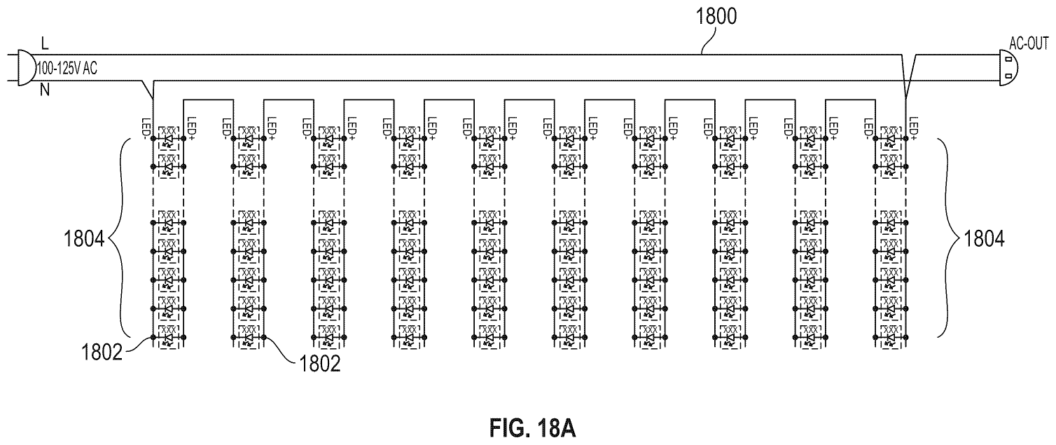

FIG. 18a is a circuit diagram illustrating groups of LEDs (collectively 1802) on a single light string 1800 forming a number of connected light sources (collectively 1804). The single light string 1800 can be plugged directly into a 100V-230V power source. As illustrated in FIGS. 18b and 18c, respectively, each group 1800′, 1800″ of LEDs (collectively 1802′, 1802″) can have the same or different number of LED chips.

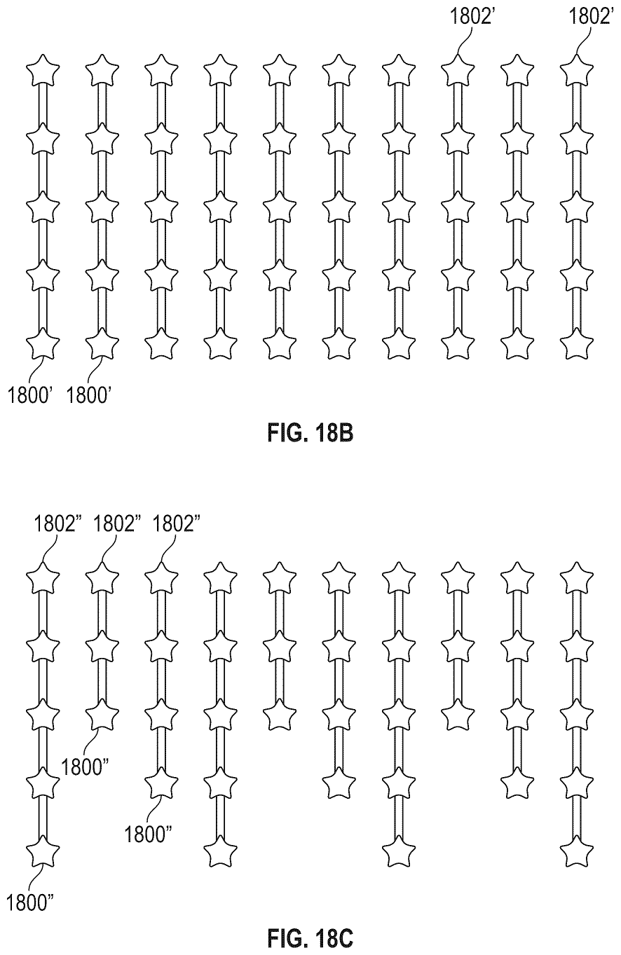

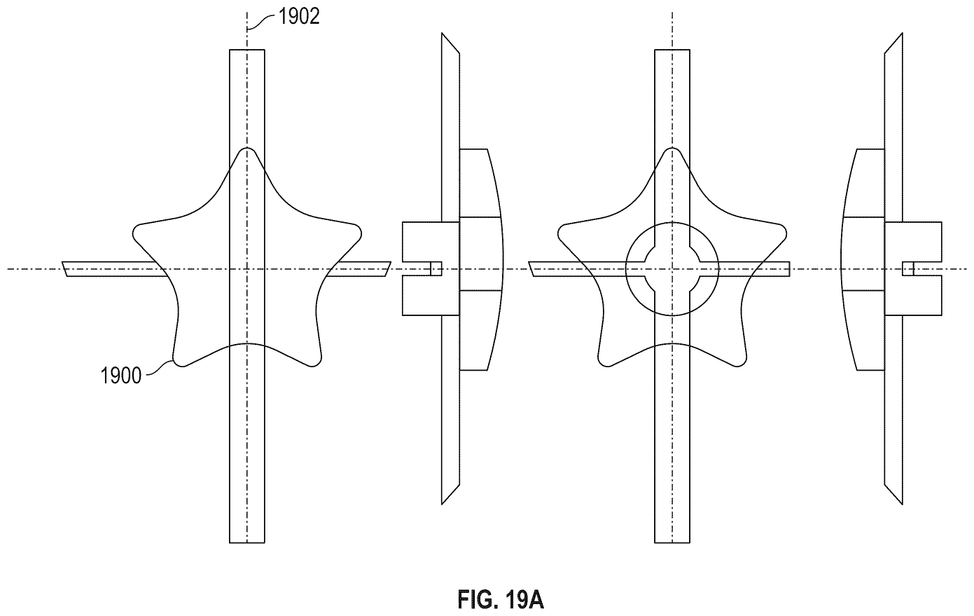

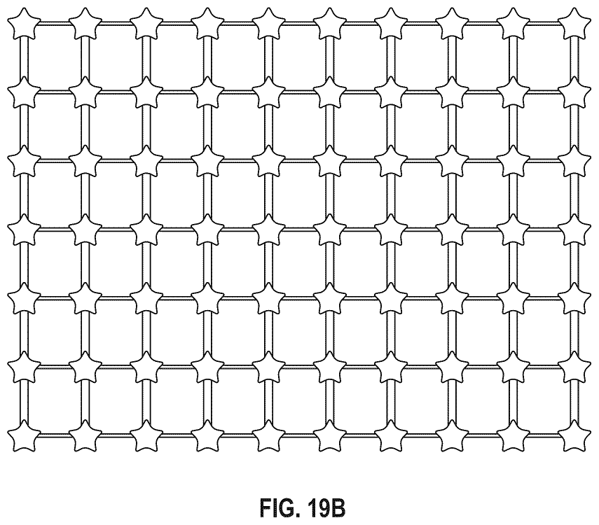

FIG. 19a illustrates, from different viewpoints, special fasteners 1900 used for clamping and support wires 1902 to form net lights such as those shown in FIG. 19b. As illustrated in FIG. 19a, the shape of the fasteners 1900 can be star shaped, spherical, or any other shape. The net lighting 1910 can include a matrix of LEDs (collectively 1912) that are connected by horizontal cables 1914 and vertical cables 1916. Either the horizontal cables 1914 or the vertical cables 1916 can be the 4-wire or 5-wire flat cables discussed above, with some of the wires in the flat cables cut at certain locations to form parallel and/or series connections as detailed in the embodiments discussed above. If the vertical cables 1916 are the 4-wire or 5-wire flat cables running electricity, the horizontal cables 1914 would be dummy cables whose main function is to form the “net,” and vice versa.

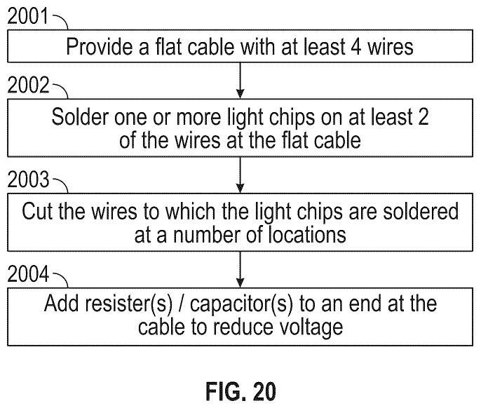

FIG. 20 is a flow chart illustrating the exemplary steps in a method of making a string light, according to an embodiment of the disclosure. First, a flat cable including at least 4 wires is provided. (Step 2001) The flat cable can be a 4-wire or 5-wire flat cable. Next, one or more light chips (e.g., LED chips) can be soldered on at least 2 of the wires of the flat cable. (Step 2002) Depending on whether a 4-wire or 5-wire flat cable is used, each light chip can be soldered on 2 or 3 wires of the flat cable, respectively. The wires on which the light chips are soldered are cut at a number of locations to create different connections among the light chips. (Step 2003) Finally, the voltage of the flat cable can be reduced by adding resistor(s) or a combination of resistor(s) and capacitor(s) to an end of the cable. (Step 2004)

In another aspect of the disclosure, embodiments of a fused current tap and a cord connector for a high voltage direct insert light string are disclosed.

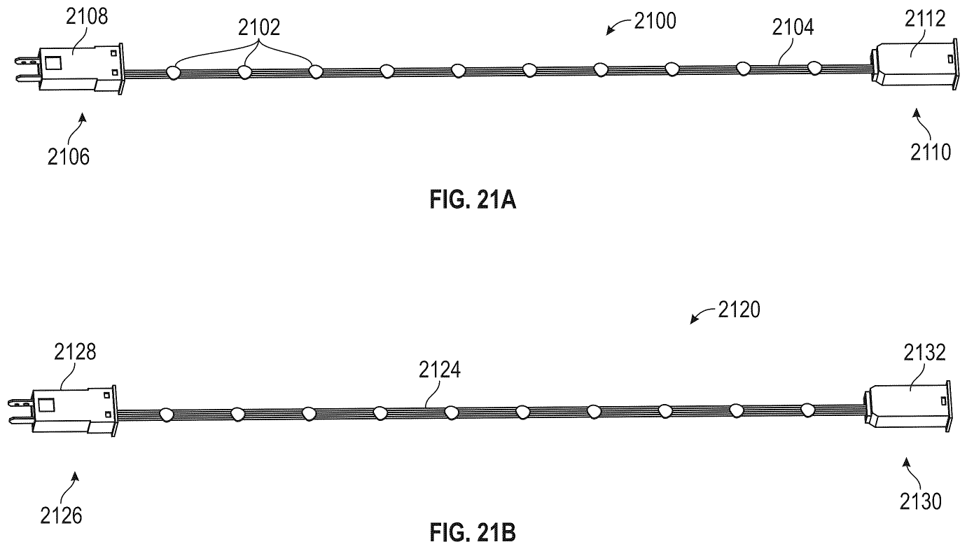

FIG. 21A is a schematic diagram of string light made from a 5-wire flat cable, according to an embodiment of the disclosure. The string light 2100 includes multiple LED lights 2102 connected by a 5-wire flat cable 2104. The string light 2100 can be manufactured using the methods discussed in the embodiments above. In this embodiment, a first end 2106 of the string light 2100 can include a fused current tap 2108 and the second end 2110 of the string light 2100 can include a cord connector 2112.

FIG. 21B illustrates a string light 2120 similar to the string light 2100 of FIG. 21A except that the string light 2120 of FIG. 21B is made from a 4-wire flat cable 2124. The string light 2120 of FIG. 21B can be manufactured using the methods discussed in the embodiments above. In this embodiment, a first end 2126 of the string light 2120 can include a fused current tap 2128 and the second end 2130 of the string light 2120 can include a cord connector 2132.

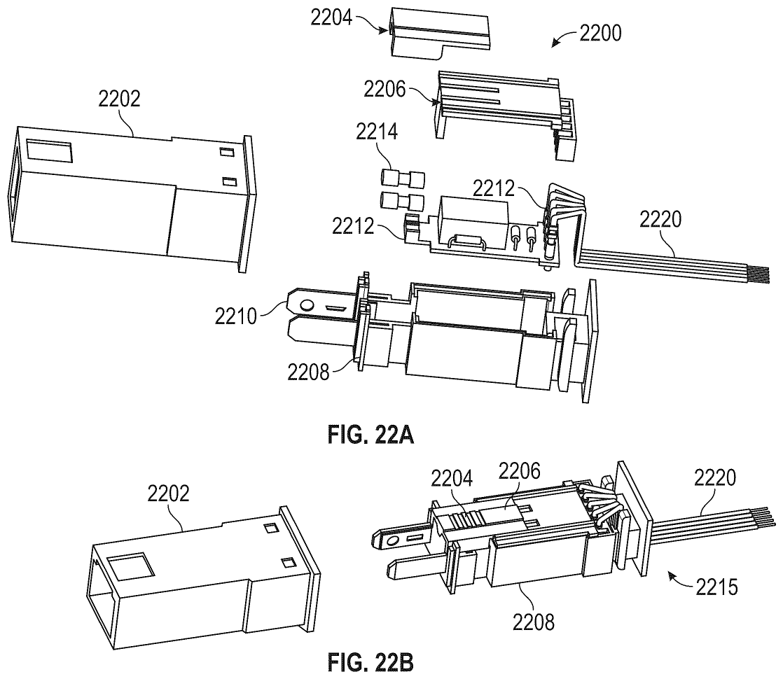

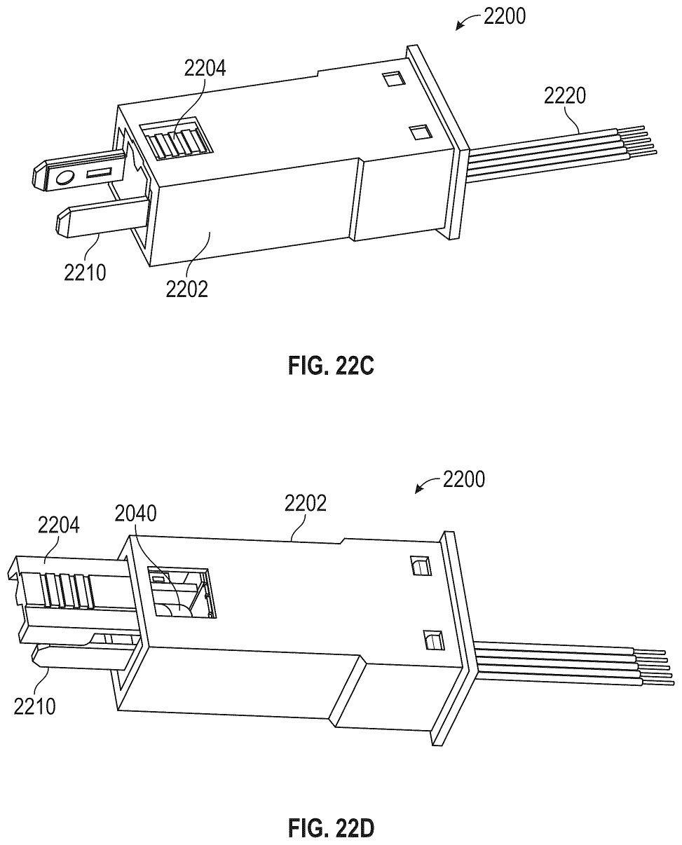

FIG. 22A is an exploded diagram of an assembly of a fused current tap 2200 such as the fused current taps 2108 and 2128 of FIGS. 21A and 21B, according to an embodiment of the disclosure. The fused current tap 2200 includes a shell 2202, a push cover 2204, an upper cover 2206, an inner box 2208 having a number of copper blades 2210 protruding from one end, a printed circuit board (PCB) 2213 having contact 2212 and fuse 2214. The contact 2212 can connect to the wires 2220 of the flat cable of the string light. Although 2 copper blades 2210 are shown to protruding from one end of the inner box 2208, it should be understood that the blades can be made of other metals and there may be a different number of blades in other embodiments.

FIG. 22B illustrates a partially assembled fused current tap 2200 of FIG. 22A. As illustrated, the inner box 2208 can hold the PCB 2212, the fuse 2214, and contact 2212 with the wires 2220 connected to the contact 2212 and extending from one end 2215 of the inner box 2208. The upper cover 2206 can be placed to cover the top of the inner box 2208. The push cover 2204 can be placed on top of the upper cover 2206, partially overlapping with the upper cover 2206.

FIG. 22C illustrates a fully assembled fused current tap 2200. Here, the partially assembled fused current tap 2200 of FIG. 22B is inserted into the shell 2202 such that the copper blades 2210 of the inner box extend from one end of the fused current tap 2200 and the wires 2220 of the flat cable extend from the other end of the fused current tap 2200. The push cover 2204 is inside of the shell 2202 but visible and exposed through a window 2240 on top of the shell 2202.

FIG. 22D illustrates the fully assembled fused current tap 2200, but with the push cover 2204 extending from the shell 2202. Various mechanisms can be used to release the push cover 2204 from inside of the shell 2202. For example, the push cover 2204 can be pushed down through the window 2240 to be released. When the push cover 2204 is extended from the shell 2202, it can prevent the copper blades 2210 from being inserted into a plug.

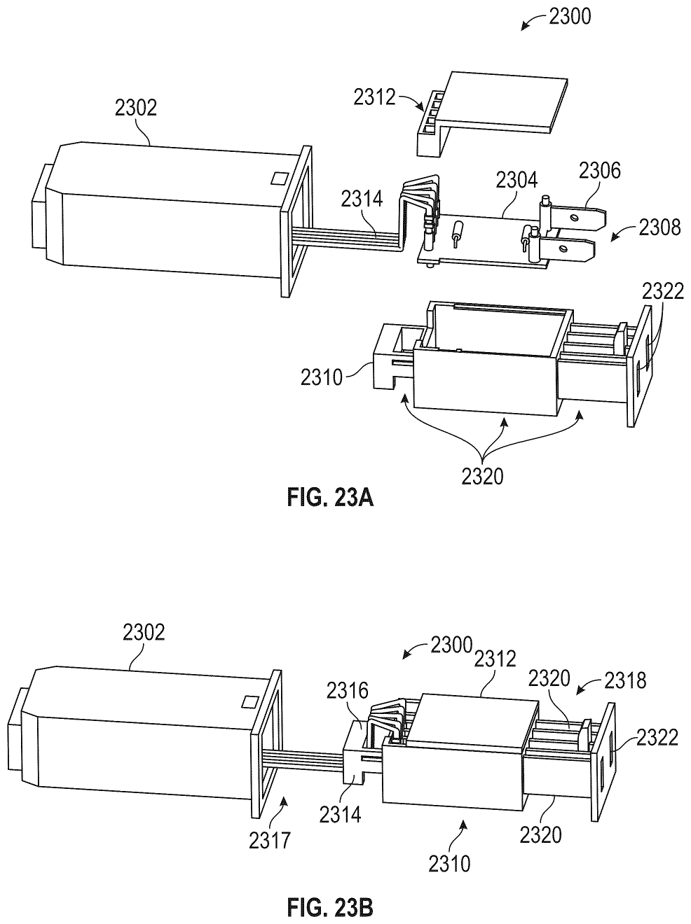

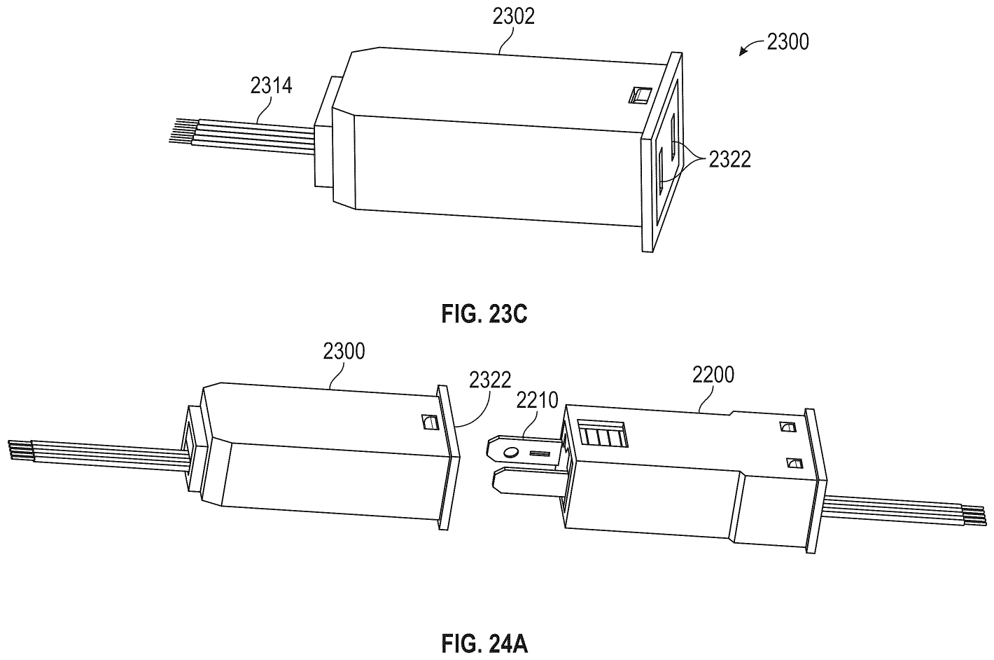

FIG. 23A is an exploded diagram of an assembly of a cord connector 2300, according to an embodiment of the disclosure. The cord connector 2300 includes a shell 2302, wires 2314 extending from the shell 2302 and connected to a PCB 2304. The PCB 2304 can include a number of copper blades 2306 extending from an end 2308 opposite to the wire connections 2314. The cord connector 2300 of FIG. 23A can also include an inner box 2310 and an upper cover 2312. The inner box 2310 can include slots 2320 that can fit the PCB 2304 and the copper blades 2306.

FIG. 23B illustrates the cord connector 2300 of FIG. 23A partially assembled. The PCB 2304 is placed in the inner box 2310 and covered on top by the upper cover 2312. The wire connections 2314 can be routed through various slots 2316 at one end 2317 of the inner box 2310. The other end 2318 of the inner box 2310 can be exposed from under the upper cover 2313. The exposed end 2318 of the inner box 2310 includes the slots 2320, in which the copper blades 2306 are fitted. At the very end of the exposed end 2318 are sockets 2322 for receiving copper blades of a fused current tap (not shown in FIG. 23B. Although two sockets 2322 are shown in FIG. 23A, it should be understood that the number of sockets may be different, depending on the number of blades from the corresponding fused current tap.

FIG. 23C illustrates a fully assembled cord connector 2300 of FIG. 23A. The inner box 2310 with the upper cover 2313 is fully fitted into the shell 2302 with the wires 2314 extending from one end 2318 of the shell 2302. The opposite end 2320 of the shell 2302 exposes the sockets 2322 at the end of the inner box 2310.

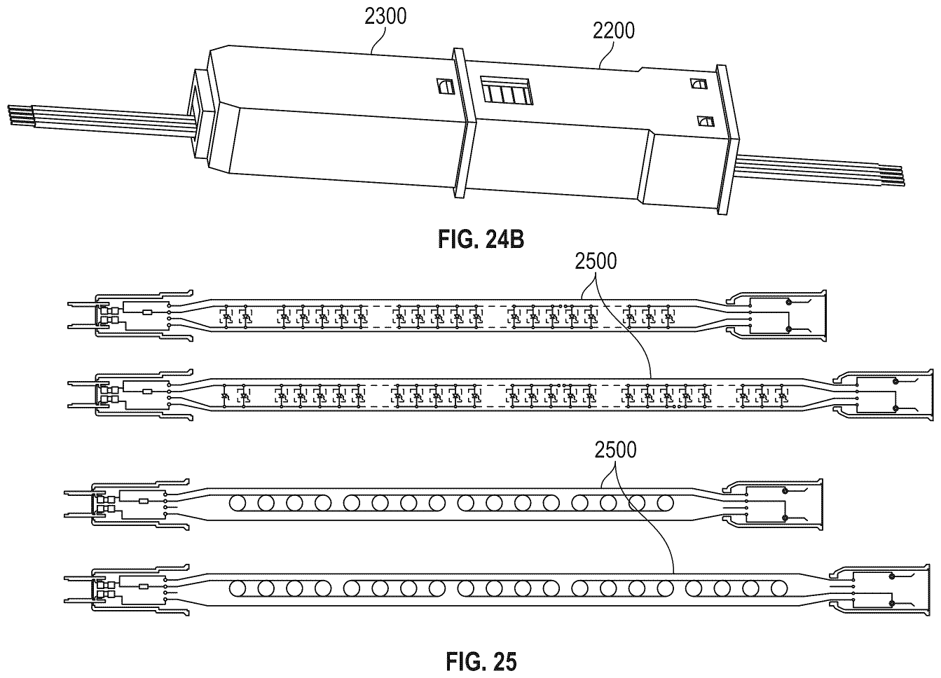

FIG. 24A illustrate the fused current tap 2200 of FIG. 22A and the cord connector 2300 of FIG. 23A. The copper blades 2210 of the fused current tap 2200 is positioned to be inserted into the sockets 2322 of the cord connector 2300.

FIG. 24B illustrates the fused current tap 2200 of FIG. 22A and the cord connector 2300 of FIG. 23A engaged with the copper blades 2210 of the fused current tap inserted into the sockets 2322 of the cord connector 2300. When engaged, the copper blades 2210 of the fused current tap 2200 can be in contact with the copper blades 2306 of the cord connector 2300.

FIG. 25 is a circuit diagram of exemplary string lights 2500 without any rectifier circuit, according to an embodiment of the disclosure.

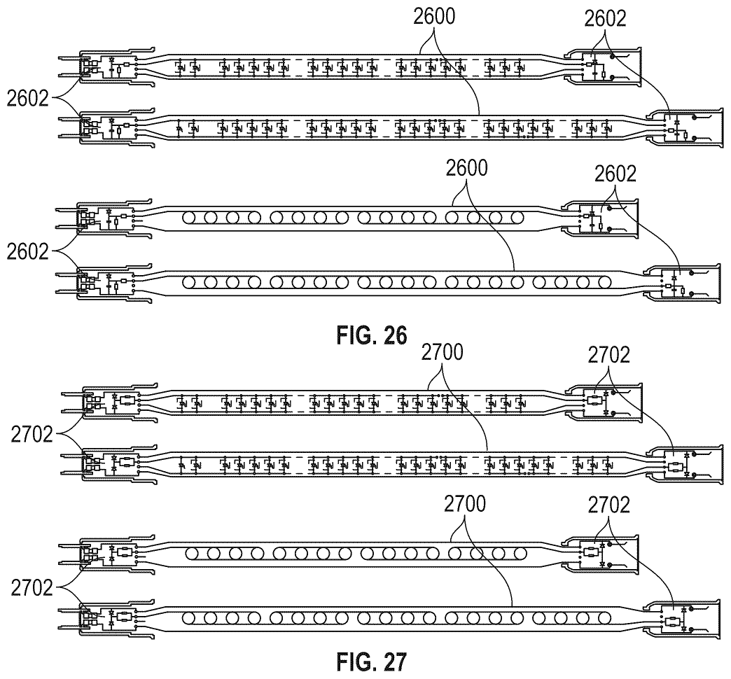

FIG. 26 is a circuit diagram of exemplary string lights 2600 with rectifier circuits 2602, according to an embodiment of the disclosure.

FIG. 27 is a circuit diagram of exemplary string lights 2700 with rectifier circuits 2702, according to another embodiment of the disclosure.

The basic principles and main features of the present are shown in the figures and described above. Those skilled in the art should understand that the present invention is not limited by the above embodiments, the above embodiments and the description in the specification are only illustrative of the principles of the present invention. Various variations and improvements of the present invention also exist without departing from the spirit and scope of the present invention, and they all fall within the scope of the present disclosure sought for protection.

What is claimed is:

1. A fused current tap comprising:
an inner box having a plurality of metal blades protruding from a first end and slots at a second end opposite to the first end for receiving a plurality of wires;
a printed circuit board (PCB) comprising a contact connectable to the plurality of wires;
an upper cover covering at least a part of a top side of the inner box;
a push cover on top of the upper cover, partially covering the upper cover; and
a shell configured to house the inner box, the upper cover, and the push cover,
wherein the shell comprises an opening via which the plurality of metal blades are exposed; and
wherein the shall comprises a window on a top surface for releasing the push cover to a position that is on top of the exposed metal blades.

2. The fused current tap of claim 1 further comprising one or more fuses, wherein the one or more fuses is housed in the inner box.

3. The fused current tap of claim 1, wherein the contact is connectable to 4 wires.

4. The fused current tap of claim 1, wherein the contact is connectable to 5 wires.

5. The fused current tap of claim 1, further comprises a rectifier circuit.

6. A cord connector comprising:
an inner box configured to house a PCB connectable to a plurality of wires;
a first plurality of metal blades attached to and extending from the PCB;
an upper cover covering at least a part of a top side of the inner box; and
a shell configured to house the inner box and the upper cover,
wherein the first plurality of metal blades fit into corresponding plurality of slots at a first end of the inner box; and
wherein the plurality of slots are configured to receive a second plurality of blades of a fused current tap.

7. The cord connector of claim 6, further comprising a rectifier circuit.

8. The cord connector of claim 6, wherein the plurality of wires consist of 4 wires.

9. The cord connector of claim 6, wherein the plurality of wires consist of 5 wires.

10. The cord connector of claim 6, wherein the plurality of wires extend from one end of the shell.

11. An extender for sting lights comprising:
a fused current tap comprising:
an inner box having a first plurality of metal blades protruding from a first end and slots at a second end opposite to the first end for receiving a plurality of wires;
a printed circuit board (PCB) comprising a contact connectable to the plurality of wires;
an upper cover covering at least a part of a top side of the inner box;
a push cover on top of the upper cover, partially covering the upper cover; and
a shell configured to house the inner box, the upper cover, and the push cover,
wherein the shell comprises an opening via which the first plurality of metal blades are exposed; and
wherein the shall comprises a window on a top surface for releasing the push cover to a position that is on top of the exposed first plurality of metal blades; and
a cord connector comprising:
an inner box configured to house a PCB connectable to a plurality of wires;
a second plurality of metal blades attached to and extending from the PCB;
an upper cover covering at least a part of a top side of the inner box; and
a shell configured to house the inner box and the upper cover,
wherein the second plurality of metal blades fit into corresponding plurality of slots at a first end of the inner box; and
wherein the plurality of slots are configured to receive the first plurality of blades of the fused current tap.

12. The extender for string lights of claim 11, wherein the first plurality of blades and the second plurality of blades are in contact when the fused current tap and the cord connector are engaged.
